(19) United States
(12) Patent Application Publication
(10) Pub. No.: US 2011/0241867 A1
(43) Pub. Date: Oct. 6, 2011

(54) SUMMER ALERT SYSTEMS

(76) Inventor: Cornelius I. Neal, La Mesa, CA (US)

(21) Appl. No.: 13/078,961

(22) Filed: Apr. 2, 2011

Related U.S. Application Data
(60) Provisional application No. 61/320,367, filed on Apr. 2, 2010.

(51) Int. Cl. G08B 21/02

(52) U.S. Cl. 340/457

(57) ABSTRACT

An alarm device of the infant car seat alarm system may comprise a transmitter and receiver system whereby a vehicle user will be alerted audibly upon the inadvertent abandonment of an infant or pet inside a vehicle when the vehicle is parked and has been or is about to be exited.

### CROSS-REFERENCE TO RELATED APPLICATION

The present application is related to and claims priority from prior provisional application Ser. No. 61/320,367, filed Apr. 2, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of alarm devices and more specifically relates to a device to detect the presence of a baby in a car seat and to alert the parent or guardian that an infant may still be in a vehicle.

2. Description of the Related Art

Many individuals within modern society use automobiles as a means of transportation between various locations. Often times infants travel with their caregivers in these vehicles. Infant car seats, often required by law, provide a restraint which may be secured to the seat of an automobile equipped with safety harnesses to hold safe an infant in the event of a car crash. Booster seats may be used to restrain children who are too large for infant car seats. The children must be large enough so they properly fit a seat belt to be transported in booster seats. Many times when adults exit a vehicle they may forget to take their children with them, potentially causing severe harm to the child from kidnapping, heat exhaustion, freezing or other such dangerous conditions. The infant may be ‘buckled in’ so they are not free to escape the dangers present.

Alarm devices have may provide alerts for various purposes. Conventional uses of alarms are to alert people of important dates, a particular time, or an occurrence of an event. Further, alarms may also be used to warn people of danger or may serve as deterrence to crime, such as theft or vandalism. Alarms may be unreliable and may not be user-friendly in many instances.

Various attempts have been made to solve the above-mentioned problems such as those found in U.S. Pat. Nos. U.S. Pat. No. 6,509,653 to Fujimoto; U.S. Pat. No. 7,106,207 to Marchan; and U.S. Pat. No. 7,319,382 to Vu. This prior art is representative of alarms. None of the above inventions and patents, taken either singly or in combination, is seen to describe the invention as claimed.

Ideally, an alarm device for use with a infant car seat should be user-friendly yet, would operate safely, reliably and be manufactured at a modest expense. Thus, a need exists for a reliable infant car seat alarm system to prevent an infant from being left unattended in an infant car seat and to avoid the above-mentioned problems.

### BRIEF SUMMARY OF THE INVENTION

In view of the foregoing disadvantages inherent in the known alarm art, the present invention provides a novel infant car seat alarm system. The general purpose of the present invention, which will be described subsequently in greater detail is to provide a reliable and safe infant car seat alarm system to warn drivers that an infant is about to be left unattended. The infant car seat alarm system is designed to promote safety for infants and children.

An infant car seat alarm system is disclosed herein preferably comprising: a deformable air bag comprising a seat-mountable pad (low-profile) having an outer surface portion enclosing a confined inner volume; at least one pressure switch to sense a weight of an infant; a transmitter; at least one receiver; an audibilizer; and an air tube connected between the pressure switch and the seat-mountable pad. In a preferred embodiment the deformable air bag is placed under an infant car seat so that it may detect a presence (weight) of the infant. The deformable air bag is in communication with the pressure switch to sense a presence of the infant via a load-pressure present (or absent) in the infant car seat. The pressure switch is in communication with the transmitter, the transmitter is in remote communication with the receiver to send at least one signal as an indication of an occupied condition when the infant is present in the infant car seat.

In the preferred version the receiver is located within a key fob. Additionally an audibilizer is preferably located within the key fob; wherein the audibilizer is able to audibilized/sound a spoken word and/or an alarm tone to provide at least one warning to the driver of the child being restrained in the infant car seat; left unattended. The transmitter may be mounted under a dash of the vehicle or in another suitable location as per user or manufacturer preference. The air tube is such that it carries a maintained compressed volume of air from the confined inner volume to the pressure switch when downward pressure from the child (weight) is imparted on the deformable air bag as the deformable air bag is depressed (compressed.) The deformable air bag is normally in tension so as to push up on the infant car seat because of the air pressure contained within its confines. The pressure switch, based on the information sent from the deformable air bag (via movement of air or other) is able to determine whether or not there is an occupied condition present by a analyzing the relative load-pressure as compared to a known weight range of said infant (known unloaded and loaded condition pre-programmed or set.)

In certain preferred embodiments the receiver is in communication with the audibilizer such that the receiver is able to actuate a warning signal (beep, buzz, spoken voice or other sound transmitted via sound waves propagating through an air medium) via the audibilizer to warn the driver of the occupied condition when the vehicle is parked and upon the driver exiting a door.

The infant car seat alarm system may further comprise a kit as described herein including: the deformable air bag; the pressure switch; the transmitter; the receiver and audibilizer contained in a key fob; and at least one air tube (or other electrical/pneumatic/hydraulic or other communicator means); wherein the kit is available for at least one monetizing (on sale) event.

A method is additionally disclosed herein for using the infant car seat alarm system of the present invention comprising the steps of: installing the infant car seat alarm system; setting an infant car seat on a deformable air bag in communication with a pressure switch (buckling in the infant car seat), a transmitter, a receiver and an audibilizer contained in a key fob; and positioning and restraining an infant in the infant car seat for at least one travel session. The method may also comprise additional steps of the driver shutting off the vehicle (or not) and exiting the vehicle whereupon a signal is received by the key fob warning the driver (caregiver) that the infant is still in the infant car seat (unattended.)

The present invention holds significant improvements and serves as an infant car seat alarm system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, “Summer Alert”, constructed and operative according to the teachings of the present invention.

FIG. 1 shows a perspective view illustrating an infant car seat alarm system entitled “Summer Alert” in an in-use condition according to an embodiment of the present invention.

FIG. 2 shows a perspective view illustrating a transmitter and receiver with a pressure switch, components of the infant car seat alarm system according to an embodiment of the present invention of FIG. 1.

FIG. 3 is a flowchart illustrating the infant car seat alarm system, “Summer Alert,” according to an embodiment of the present invention of FIGS. 1-2.

The various embodiments of the present invention will hereinafter be described in conjunction with the appended drawings, wherein like designations denote like elements.

### DETAILED DESCRIPTION

As discussed above, embodiments of the present invention relate to an alarm device and more particularly to an infant car seat alarm system as used to prevent children and/or pets from being left unattended in a vehicle. As mentioned previously, unfortunately children may be left unattended in vehicles by their caregivers potentially leading to dangerous conditions. On hectic and busy days, it can be very easy for adults to experience momentary confusion and lapses in judgment. Unfortunately, leaving a child alone in a car, even for a short period of time, can lead to tragic circumstances, especially on hot days. As disturbing as the thought may be, the facts are indisputable. During summer months it may only take a few minutes for the temperature inside a car, even with the windows cracked, to rise to a dangerous level.

According to experts, even on a mild 73 degree F. day, a vehicle such as an SUV can heat up to 100 degrees F. in 10 minutes, and to 120 F. in just 30 minutes. As the outdoor temperature increases, so does the heat build-up inside a vehicle. With a temperature of 90 degrees, the interior of a vehicle can heat up to 160 degrees within several minutes quickly causing damage to a child's respiratory system leading to heat exhaustion and possible death. As a result, a mere momentary lapse in judgment by a distracted parent could lead to tragic results of an infant forgotten but for only minutes inside a vehicle. Generally, the infant car seat alarm system entitled “Summer Alert” serves as a system to provide an audible and visible reminder (alerting means) to the fact that a child or pet has been accidentally left inside a vehicle to solve the above-mentioned problems. The Summer Alert may comprise an automobile alarm transmitting and receiving system that may alert a vehicle owner that the vehicle is still occupied with a child or pet when the system detects that the car has been parked.

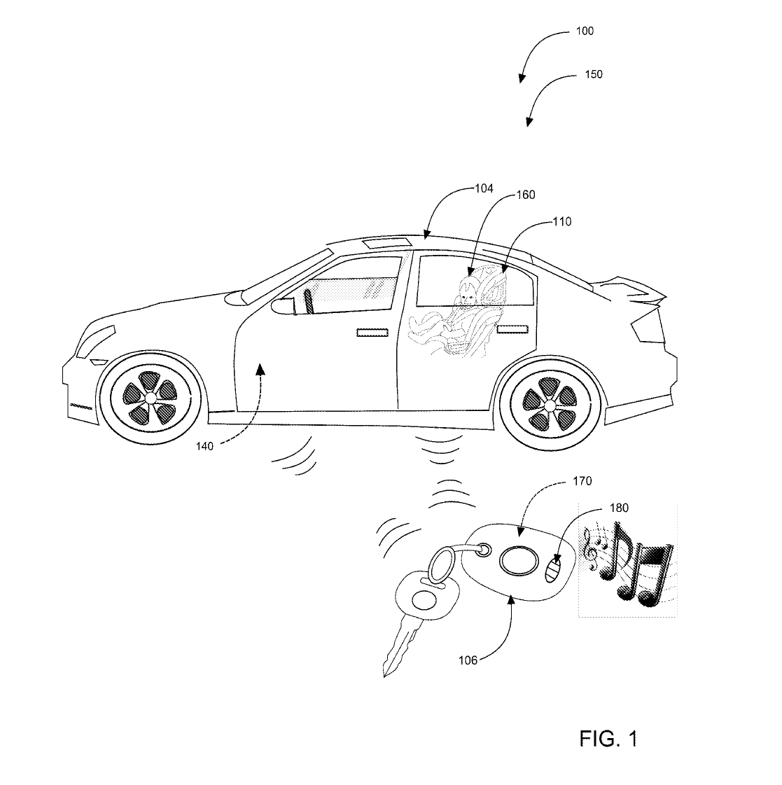

Referring now to the drawings with specificity by numerals of reference there is shown in FIG. 1, a perspective view illustrating infant car seat alarm system 100 entitled “Summer Alert” in an in-use condition 150 according to an embodiment of the present invention.

Infant car seat alarm system 100 preferably comprises: deformable air bag 120 (or non-deformable in alternate embodiments); at least one pressure switch 130 to sense a weight of infant 160; transmitter 140; at least one receiver 170; and audibilizer 180. Deformable air bag 120 is preferably placed under infant car seat 110 on substantially planar seat upper surface. In certain embodiments deformable air bag 120 may be coupled to planar seat upper surface via suitable securing means such as hook and loop fasteners or the like whereby deformable air bag 120 is keep stationary. Those with ordinary skill in the art will now appreciate that upon reading this specification and by their understanding the art of transmitters, receivers, speakers, and pressure sensitive switches and sensors as described herein, methods of communication will be understood by those knowledgeable in such art.

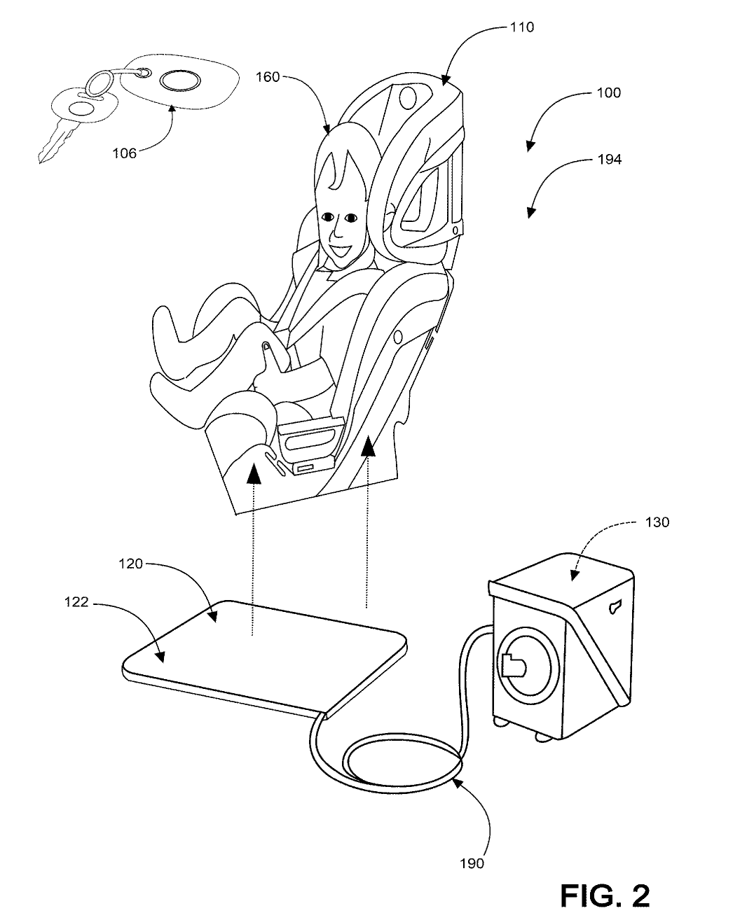

Deformable air bag 120 is preferably in communication with at least one pressure switch 130 to sense a presence of infant 160 via a load-pressure present (or absent—weight reduced) in infant car seat 110. Pressure switch 130 is preferably in communication with transmitter 140; and wherein transmitter 140 is in remote communication with receiver 170 to send at least one signal as an indication of an occupied condition when infant 160 is present in infant car seat 110. Receiver 170 is preferably in communication with audibilizer 180 such that receiver 170 is able to actuate a warning signal via audibilizer 180 to warn a driver (caregiver/parent or other) of an occupied condition when vehicle 104 is parked and the driver exits a door. The opening of the door, closing of the door, shutting off vehicle 104, putting vehicle 104 in park, setting an emergency brake or other such event or condition may create a situation whereby the warning is dispatched. The warning is not relayed in the event that infant car seat 110 is not occupied. Deformable air bag 120 may be sat on by infant 160 (as indicated by arrows in FIG. 2) directly or indirectly so also provides cushioning means (normally it is positioned within infant car seat 110 however in other embodiments may be located under infant car seat 110.)

In certain embodiments receiver 170 is located within key fob 106, as indicated in FIG. 1. Additionally, audibilizer 180 may be located within key fob 106. Audibilizer 180 may comprise an electroacoustic transducer that produces sound (audibilizes) a spoken word in response to an electrical audio signal output. Audibilizer 180 comprises speaker also having the ability to audibilize an alarm tone. In preferred embodiments of infant car seat alarm system 100 audibilizer 180 audibilizes (or otherwise propagates) a spoken word and/or an alarm tone to provide at least one warning. In other embodiments key fob 106 may produce a warning via vibration or other. Receiver 170 may use challenge-response authentication over radio frequency protocol or infrared technology. Those with ordinary skill in the art will now appreciate that upon reading this specification and by their understanding the art of key fobs as described herein, methods of key fob functioning will be understood by those knowledgeable in such art.

Transmitter 140 may be mounted under a dash of vehicle 104. Transmitter 140 may be mounted in alternate locations within vehicle 104 according to installer/user/manufacturer preference. Transmitter 140 is preferably in communication with a transmitting device installed within key fob 106 that may be easily secured to virtually any keychain. Internally contained within the transmitter's durable plastic housing, a microchip is pre-programmed so that a speaker provides an audible warning of both the recorded message of “BABY!” (or other audibilized verbiage) and/or a piercing alarm.

The Summer Alert may further comprise a free-standing receiving device that may be square in shape, as shown in FIG. 2, and may be placed on the floor or an empty seat inside vehicle 104. Receiver 170 may further comprise an elongated, pyroelectric or infrared sensor which may be incorporated into the design of an elongated air tube which extends from the unit and may be placed directly beneath infant 160, or directly on the vehicle seat cushion below infant car seat 110. The deformable air bag 120 may comprise a pressure sensitive switch as to be able to detect the weight of infant 160 (or pet.) The various components of infant car seat alarm system 100 may be powered by battery of vehicle 104 or by other suitable battery power, while key fob 106 may utilize a battery source such as the micro-alkaline or silver oxide cell batteries.

When a motorist has parked vehicle 104 using the Summer Alert and prepares to exit vehicle 104 with infant 160 left remaining in his or her infant car seat 110, the alarm will be activated, emitting a piercing beeping sound, which may alert the driver that infant 160 or pet is still inside vehicle 104. Should the user attempt to override the system by continuously attempting to lock the doors, the weight or heat sensor of the receiving device (seat base or other in alternate embodiments or deformable air bag 120 in preferred embodiments) would detect infant 160 still in infant car seat 110, and the audible warnings would continue until infant 160 is unhooked from infant car seat 110 and removed from vehicle 104. In certain embodiments other vehicle functional systems may also be activated such as horn blowing, windows being ‘rolled’ down or the like. Further, utilizing state of the art technology, the present invention may detect a still-latched seat beat, and even the weight or heat of infant 160, in a matter of seconds. In this manner, the forgetful adult would be provided with a clear, audible reminder that they must return to vehicle 104 immediately.

The Summer Alert may effectively prevent rushed and harried parents from unintentionally leaving behind a helpless infant 160 in vehicle 104. While most adults would never willfully put their loved ones at risk, the Summer Alert would provide a way for them to avoid the accidental abandonment of infant 160 in a hot, confined vehicle 104. The embodiment of the present invention may be easily removably retrofitted into new and/or ‘used’ vehicle(s) 104. Alternately, vehicle 104 may come OEM with the present invention installed therein.

In an alternative function of the present invention, the Summer Alert may also provide the same security and alert to pet owners. The pressure sensitive receiver may effectively prevent a pet owner from forgetting that they have forgotten a beloved dog or cat. In this way infant car seat alarm system 100, the Summer Alert may provide owners and drivers of vehicle 104 with confidence and peace of mind Preventing the accidental leaving of infant 160 in a sweltering vehicle, the alarm device of the present invention may effectively prevent serious injury or even death.

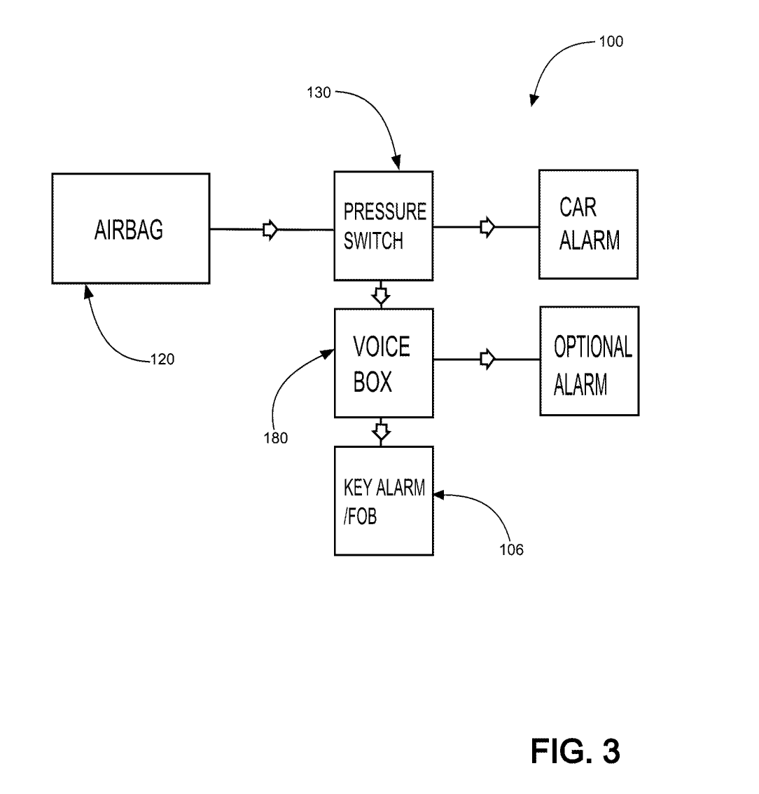

Referring now to FIGS. 2 and 3; FIG. 2 showing a perspective view illustrating transmitter 140 and receiver 170 with pressure switch 130, components of infant car seat alarm system 100 and FIG. 3, a flowchart 350 illustrating components of infant car seat alarm system 100, “Summer Alert,” according to an embodiment of the present invention of FIG. 1.

Infant car seat alarm system 100, as mentioned previously, preferably comprises at least one pressure switch 130; pressure switch 130 based on information sent from deformable air bag 120 is able to determine an occupied condition (or unoccupied condition) by ‘analyzing’ load-pressure as compared to a known weight range of infant 160. In a preferred embodiment deformable air bag 120 comprises a seat-mountable pad 122. Seat-mountable pad 122 comprises a confined inner volume and an outer surface area enclosing the inner volume such that air may be confined therein. Further, deformable air bag 120 is preferably connected to pressure switch 130 via at least one air tube 190; wherein air tube 190 may carry a maintained compressed volume of air from the confined inner volume of deformable air bag 120 (seat-mountable pad 122) to pressure switch 130. In the above-mentioned manner the various components of infant car seat alarm system 100 are in communication such that infant 160 may be suitably protected. It should also be appreciated that other communication means such as electrical embodiments/means or the like may be used to achieve an equivalent result and that the disclosure herein should not be limited to the expressed embodiments, but rather that these embodiments have been presented as an enabling means and should not be construed to be limiting.

The infant car seat alarm system 100 may further comprise a kit 194 including: deformable air bag 120; at least one pressure switch 130; transmitter 140; at least one receiver 170 and audibilizer 180 (preferably) contained in key fob 106; and air tube 190; wherein kit 194 is available for at least one monetizing event. Infant car seat alarm system 100 may further comprise a set of user instructions. Infant car seat alarm system 100 may be manufactured and provided for sale in a wide variety of sizes and shapes for a wide assortment of applications. For aftermarket retrofitting, package instructions for installation should be followed to effectively ensure proper placement of the equipment, the instructions preferably available in multiple languages. After attaching the handheld transmitter to a keychain (key fob 106), the Summer Alert is ready for use (also see method of use below.) Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

A method for using infant car seat alarm system 100 of the present invention may comprise the steps of: installing infant car seat alarm system 100; setting infant car seat 110 on deformable air bag 120 in communication with pressure switch 130, transmitter 140, receiver 170 and audibilizer 180 contained in key fob 106; and positioning and restraining infant 160 in infant car seat 110 for at least one travel session. The method may also comprise additional steps of the driver shutting off vehicle 104 (or not) and exiting vehicle 104 whereupon a signal is received by key fob 106 warning driver (caregiver) that infant 160 is still present in infant car seat 110. It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An infant car seat alarm system comprising:
a deformable air bag;
at least one pressure switch to sense a weight of an infant;
a transmitter;
at least one receiver; and
an audibilizer;
wherein said deformable air bag is placed under an infant car seat;
wherein said deformable air bag is in communication with said at least one pressure switch to sense a presence of said infant via a load-pressure present or absent in said infant car seat;
wherein said at least one pressure switch is in communication with said transmitter;
wherein said transmitter is in remote communication with said receiver to send at least one signal as an indication of an occupied condition when said infant is present in said infant car seat; and
wherein said receiver is in communication with said audibilizer such that said receiver is able to actuate a warning signal via said audibilizer to warn a driver of said occupied condition when a vehicle is parked and said driver exits a door.

2. The infant car seat alarm system of claim 1 wherein said receiver is located within a key fob.

3. The infant car seat alarm system of claim 2 wherein said audibilizer is located within said key fob.

4. The infant car seat alarm system of claim 3 wherein said audibilizer audibilizes a spoken word.

5. The infant car seat alarm system of claim 3 wherein said audibilizer audibilizes an alarm tone.

6. The infant car seat alarm system of claim 3 wherein said audibilizer audibilizes a spoken word and an alarm tone to provide at least one warning.

7. The infant car seat alarm system of claim 1 wherein said transmitter is mounted under a dash of said vehicle.

8. The infant car seat alarm system of claim 1 wherein said receiver uses challenge-response authentication over radio frequency protocol.

9. The infant car seat alarm system of claim 1 wherein said receiver uses infrared technology.

10. The infant car seat alarm system of claim 1 wherein said at least one pressure switch, based on information sent from said deformable air bag is able to determine said occupied condition by analyzing said load-pressure as compared to a known weight range of said infant.

11. The infant car seat alarm system of claim 1 wherein said deformable air bag comprises a seat-mountable pad.

12. The infant car seat alarm system of claim 11 wherein said seat-mountable pad comprises a confined inner volume.

13. The infant car seat alarm system of claim 11 wherein said deformable air bag is connected to said pressure switch via an air tube.

14. The infant car seat alarm system of claim 12 wherein said air tube carries a maintained compressed volume of air from said confined inner volume to said pressure switch.

15. An infant car seat alarm system comprising:
a deformable air bag comprising a seat-mountable pad having an outer surface portion enclosing a confined inner volume;
at least one pressure switch to sense a weight of an infant;
a transmitter;
at least one receiver;
an audibilizer; and
an air tube;
wherein said deformable air bag is placed under an infant car seat;
wherein said deformable air bag is in communication with said at least one pressure switch to sense a presence of said infant via a load-pressure present or absent in said infant car seat;
wherein said at least one pressure switch is in communication with said transmitter;
wherein said transmitter is in remote communication with said receiver to send at least one signal as an indication of an occupied condition when said infant is present in said infant car seat;
wherein said receiver is located within a key fob;
wherein said audibilizer is located within said key fob;
wherein said audibilizer audibilizes a spoken word and/or an alarm tone to provide at least one warning;
wherein said transmitter is mounted under a dash of said vehicle;
wherein said air tube carries a maintained compressed volume of air from said confined inner volume to said pressure switch;
wherein said at least one pressure switch, based on information sent from said deformable air bag is able to determine said occupied condition by a analyzing said load-pressure as compared to a known weight range of said infant; and
wherein said receiver is in communication with said audibilizer such that said receiver is able to actuate a warning signal via said audibilizer to warn a driver of said occupied condition when a vehicle is parked and said driver exits a door.

16. The infant car seat alarm system of claim 15 further comprising a kit including:
said deformable air bag;
said at least one pressure switch;
said transmitter;
said at least one receiver and said audibilizer contained in said key fob; and
said air tube; and
wherein said kit is available for at least one monetizing event.

17. A method for using an infant car seat alarm system comprising the steps of:
installing said infant car seat alarm system;
setting an infant car seat on a deformable air bag in communication with a pressure switch, a transmitter, a receiver and an audibilizer contained in a key fob; and
positioning and restraining an infant in said infant car seat for at least one travel session.
